(19) United States
(12) Patent Application Publication
(10) Pub. No.: US 2026/0014841 A1
(43) Pub. Date: Jan. 15, 2026

(54) Ultra-thin embedded hard cover with reinforcing strip

(71) Applicant: ZHEJIANG SURPASS AUTO PARTS CO.,LTD., Wenzhou City (CN)

(72) Inventors: Yi Lin, Wenzhou City (CN); Lei Lin, Wenzhou City (CN)

(21) Appl. No.: 18/910,038

(22) Filed: Oct. 9, 2024

(30) Foreign Application Priority Data
Jul. 11, 2024 (CN) 202421643147.8

(51) Int. Cl. B60J 7/14

(52) U.S. Cl. CPC B60J 7/141

(57) ABSTRACT

The invention reveals an ultra-thin embedded hard cover with reinforcing strip, which involves the field of automobile parts, in order to solve the structural strength of the cover is weak, lead to that risk of deformation such as fracture and bending, as well as problems with bad sealing of the lid, including: first plate 1, second plate 2, the rotating shaft 3 and the reinforcing strip 4; The n second plates 2 are connected between the two first plates 1 through (n+1) rotating shafts 3, the first plate 1 or the second plate 2 can be folded along the rotating shaft 3, on the first plate 1 or the second plate 2, the reinforcing strip 4 is fixed in the direction parallel to its short edge, where m, n are positive integers.

### CROSS-REFERENCE TO RELATED APPLICATIONS

This application claims priority benefits to Chinese Patent Application No. 202421643147.8, filed on Jul. 11, 2024, the contents of which are incorporated herein by reference.

### TECHNICAL AREAS

The present invention relates to the field of automobile parts and components, specifically an ultra-thin embedded hard cover with reinforcing strip.

### BACKGROUND TECHNOLOGY

As a common model, most existing pickup trucks need to be covered in order to accommodate more diverse environments.

At present, the cover of the pickup truck is mostly hard cover, the cover is made of a combination of several plates, the structural strength is poor. Risk of deformation such as breakage, bending, etc. And the front and rear of the car cover is not waterproof, it is prone to water leakage. The need for a new hard cover that is waterproof and resistant to breakage and bending is urgent.

### CONTENT OF INVENTION

The embodiment of that invention provide an ultra-thin embedded hard cover with reinforcing strip to at least address the risk of deformation such as fracture, bending, etc. of the weak structural strength of the cover, and the technical problems of the lid sealing poorly;

For the purpose of achieving the above, the embodiment of the present invention shall adopt the following technical scheme:

An ultra-thin embedded hard cover with reinforcing strip, include: The first plate (1), second plate (2), rotating shaft (3) and reinforcing strip (4); the n second plates (2) are connected between the two first plates (1) through (n+1) rotating shafts (3), the first plate (1) or the second plate (2) can be folded along the rotating shaft (3), on the first plate (1) or the second plate (2), fixed connections m of reinforcing strip (4) in the direction parallel to its short edge; where m, n are positive integers.

Further, the ultra-thin embedded hard cover with reinforcing strip also includes: edge strip (5); the edge strip (5) has an edge tape bonding part (51) on one side; the edge strip (5) is used to seal the first plate (1) and/or the second plate (2).

Further, the reinforcing strip (4) and the first plate (1) or the second plate (2) fixed connection by bonding; the first glue part (D1), the first glue part (D1) and the edge tape bonding part (51) of the edge tape bonding part (51) are fixed on the mating face of the reinforcing strip (4) and the edge strip (5); there is a second gluing section (D2) on the mating face of the reinforcing strip (4) and the first plate (1), and the second gluing section (D2) is bonded and fixed with the first plate (1).

Further, the reinforcing strip (4) is fixedly connected with the first plate (1) by riveting, screws or bolts.

Further, an ultra-thin embedded hard cover with reinforcing strip, include: the first plate (1), second plate (2), rotating shaft (3) and edge strip (5); The n second plates (2) are connected between the two first plates (1) through (n+1) rotating shafts (3), the first plate (1) or the second plate (2) can be folded along the rotating shaft (3), the edge strip (5) has an edge tape bonding part (51) on one side; the first plate (1) consists of: The first plate body (11), the short frame (12) and the long frame (13); the short frame (12) and the long frame (13) are two each; the end of the short frame (12) and the long frame (13) has the third gluing part (D3) and the fourth gluing part (D4); the third gluing part (D3), the fourth gluing part (D4) edge tape bonding part (51) with the edge tape bonding part (51).

Further, the ends of the rotating shaft (3) are provided with metal or plastic parts (31), the frontage of the rotating shaft (3) or metal, or plastic parts have a sixth glue part (D6), the sixth glue part (D6) and the edge tape bonding part (51) are bonded.

### Beneficial Effect of the Invention

1. The present invention adds a reinforcing strip and is fitted to a plate body which is usually prone to breakage and bending, which not only effectively reduces the weight of the cover, it also greatly enhances the structural strength of the car cover, effectively avoid deformation risks such as breakage and bending of the car cover.
2. The present invention also provides a method of bonding of the adhesive strip, and the addition of the reinforcing strip is bonded, so that the whole hard cover can be effectively sealed, thus water-resistant and also improve the structural strength of the cover.

### SEE ILLUSTRATION

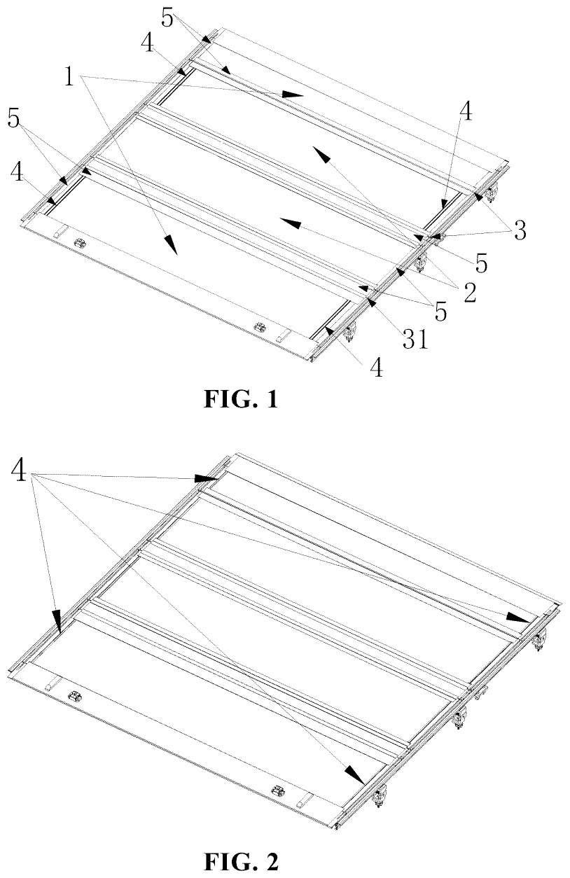

FIG. 1 is one of the schematic diagrams of an ultra-thin embedded hard cover with reinforcing strip;

FIG. 2 is the second schematic diagram of an ultra-thin embedded hard cover with reinforcing strip;

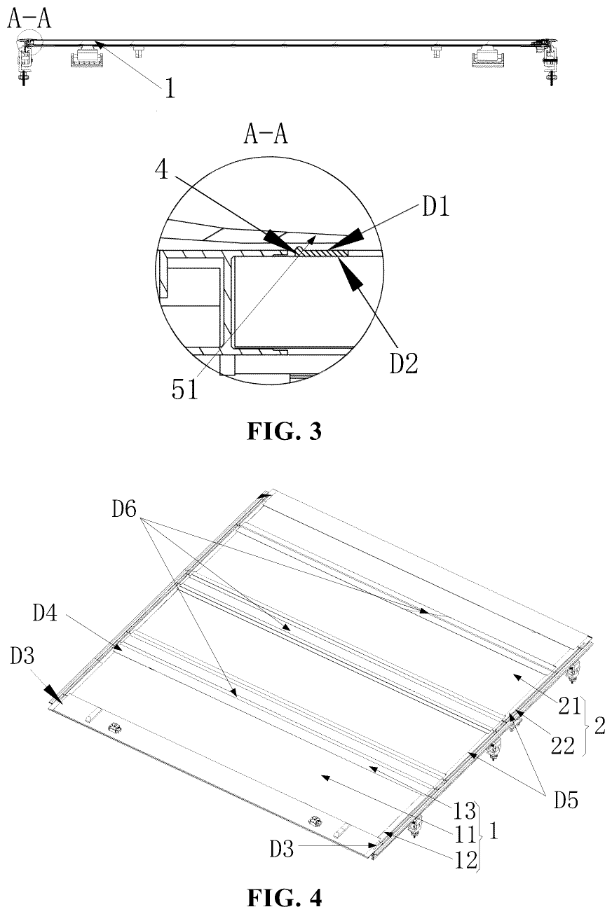

FIG. 3 is a side view section with an ultra-thin embedded hard cover with reinforcing strip and a partial section at the reinforcement;

FIG. 4 shows the third illustration of an ultra-thin embedded hard cover with reinforcing strip.

In the figure:
1, first plate, 11, first plate body, 12, short frame, 13, long frame; 2, second board, 21, second board body, 22, second frame, 3, rotating shaft, 4, reinforcing strip, 5, edge strip, 51, edge tape bonding part, D1, first glue part, D2, second gluing section, D3, third gluing part, D4, fourth gluing part, D5, fifth gluing part, D6, sixth gluing part.

### SPECIFIC IMPLEMENTATION MODALITIES

The embodiments of the invention are described in detail below in conjunction with the accompanying drawings.

In the description of the present invention, it is to be understood that the terms “center”, “up”, “down”, “front”, “back”, “left”, “right”, “vertical”, “horizontal” “rear”, ‘left’, ‘right’, ‘vertical’, “horizontal”, “top”, “bottom”, “inside”, “outside”, and other indications of the orientation or positional relationships are based on those shown in the accompanying drawings and are intended only to facilitate description of the present invention and to simplify the description, and are not intended to indicate or imply that the device or element referred to must have a particular orientation, be constructed and operated in a particular orientation, and therefore are not to be construed as a limitation of the present invention.

In the description of the invention it is necessary to state that, unless otherwise expressly stated and qualified, the term “installation”, “Connected”, “Connected” should be understood in a broad sense, for example, it can be a fixed connection, It can be a detachable connection, or a one-piece connection; it can be a mechanical or electrical connection; it can be a direct connection, or it can be connected indirectly through an intermediate medium, this can be a continuity within the two elements. For the general technician in this field, the specific meaning of the above term in the present invention may be understood in the specific case.

This application is for the existing technology, the car cover is not waterproof before and after, which is easy to leak, and the structural strength of the cover is weak, which is prone to deformation risks such as fracture and bending, in the application, by providing an adhesive tape bonding mode and adding the reinforcing strip, waterproof can be realized, and the structural strength of the cover is also improved.

As shown in FIG. 1, an ultra-thin embedded hard cover with reinforcing strip is provided by the embodiment of the present invention, include: the first plate (1), second plate (2), rotating shaft (3) and reinforcing strip (4); the n second plates (2) are connected between the two first plates (1) through (n+1) rotating shafts (3), the first plate (1) or the second plate (2) can be folded along the rotating shaft (3), on the first plate (1) or the second plate (2), fixed connections m of reinforcing strip (4) in the direction parallel to its short edge; where m, n are positive integers.

It is important to note that the first plate 1 is usually prone to fracture and bend due to force, and the reinforcing strip 4 is added on the first plate 1 in a direction parallel to the short edge of the first plate 1. Can effectively increase the strength of the first plate 1, avoid the risk of plate body breakage, bending.

The example, shown in FIG. 2, specifically identifies where the reinforcing strip 4 is installed when m=4. The following embodiment illustrates the four reinforcing strips 4 as an example when m=4.

It should be noted that the implementation of this application is illustrated in the diagram, using the example of reinforcing strip 4 on first plate 1, and that the introduction of reinforcing strip 4 on second plate 2 is similar and will not be repeated.

Optional, the material of the reinforcing strip 4 can be the same or different from the material of the first plate 1 and the second plate 2.

Optional, the reinforcing strip 4 and the first plate 1 can be fixed by riveting, screws or bolts, or by bonding. See the embodiment below for the specific bonding method.

Optional, as shown in FIG. 1, FIG. 3, the slim hard cover with the reinforcement strip also includes: Edge strip 5; one side of the edge strip 5 has edge tape bonding part 51 (edge tape bonding part 51 in FIG. 1 is obscured. Not shown, this edge strip is edge tape bonding part 51 as shown in FIG. 3). The edge strip 5 is used to seal the first plate 1 and/or the second plate 2.

Optional, in conjunction with FIG. 1, as shown in FIG. 3, the reinforcing strip 4 is bonded to either the first plate 1 or the second plate 2 for a fixed connection. In particular, the mating face of the reinforcing strip 4 and the edge strip 5 is set with the first glue D1, the first glue D1 and the edge tape bonding part 51 gluing fixing; the mating face of the reinforcing strip 4 and the first plate 1 is set with the second glue D2, the second glue D2 and the first plate 1 gluing fixing.

For example, FIG. 3 is a side view section of the entire hard cover and a partial section at the reinforcement, which has first glue part D1 set on the mating face of reinforcing strip 4 and edge strip 5 at the A-A position. The first glue part D1 is bonded to the edge tape bonding part 51; the second gluing section D2 is fitted to the mating face of the reinforcing strip 4 with the first plate 1, and the second gluing section D2 is bonded to the first plate 1.

Optional, combined with FIG. 1, as shown in FIG. 4, the first board 1 consists of: The first plate body 11, short frame 12 and long frame 13. Specific, the end of the short frame 12 and long frame 13 has the third gluing part D3 and the fourth gluing part D4; the third gluing part D3, the fourth gluing part D4 is glued with the edge tape bonding part 51. The short frame 12 and the long frame 13 are two.

FIG. 4 shows that there is a third gluing section D3 in the four short edges of the first plate body 11 (i.e. short frame 12) and a third gluing section D3 is bonded to the edge tape bonding part 51.

FIG. 4 shows that at the end of the four long edges of the first plate body 11 (i.e. the long frame 13) there is a fourth gluing section D4 and a fourth gluing section D4 is bonded to the edge tape bonding part 51.

It should be noted that the third gluing section D3 above can be set on the outside or inside of the short edge, i.e. the four short edges of the first plate body 11, and away from the direction of the second plate 2; the fourth gluing section D4 above can be set on the end of the long edge, this is the four short edges of the first plate body 11, near the direction of the second plate 2. In addition, the glue application part can be set as above when fitting reinforcing strip 4 on the second plate 2.

Optional, combined with FIG. 1, as shown in FIG. 4, the second plate 2 consists of the second board body 21 and the second frame 22. The second plate body 21 has a fifth gluing section D5 on the short edge, and the fifth gluing section D5 on the edge tape bonding part 51 bonded.

Optional, in combination with FIG. 1, the ends of the shaft 3 are fitted with metal or plastic parts 31, as shown in FIG. 4. The front of the shaft 3 or metal or plastic parts has a sixth glue part D6, the sixth glue part D6 and the edge tape bonding part 51.

Where the front of the above-mentioned shaft 3 is the side of the shaft 3 away from the cabin, i.e. toward the first plate 1 and the second plate 2.

The invention provides an ultra-thin embedded hard cover with reinforcing strip, on the one hand, an additional reinforcing strip, and is installed in a normally breakable, this not only reduces the weight of the cover, but also greatly increases the structural strength of the cover and prevents it from breaking. Effectively avoid deformation risks such as breakage and bending of the vehicle cover. On the other hand, there is also a way to bond the adhesive strip, and the added reinforcement strip is also bonded, so that the entire hard cover is effectively sealed. The result is water-resistant while also increasing the structural strength of the lid.

In the description of this specification, specific features, structures, materials or characteristics can be combined in any one or more embodiments or examples in a suitable way.

The above is only a specific implementation of the invention, but the scope of protection of the invention is not limited to this, and any technical person familiar with the technical field, within the scope of the technology disclosed in the invention, a change or replacement which can easily be contemplated shall be covered by the protection of the invention. Accordingly, the scope of protection of the invention shall be governed by the scope of protection of the claim.

1. An ultra-thin embedded hard cover with reinforcing strip, characterized in that it comprises:
The first plate (1), second plate (2), rotating shaft (3) and reinforcing strip (4);
The n second plates (2) are connected between the two first plates (1) through (n+1) rotating shafts (3), the first plate (1) or the second plate (2) can be folded along the rotating shaft (3).
On the first plate (1) or the second plate (2), fixed connections m of reinforcing strip (4) in the direction parallel to its short edge;
Where m, n are positive integers.

2. According to claim 1 the ultra-thin embedded hard cover with reinforcing strip, characterized in that the ultra-thin embedded hard cover with reinforcing strip also includes: edge strip (5);
The edge strip (5) has an edge tape bonding part (51) on one side;
The edge strip (5) is used to seal the first plate (1) and/or the second plate (2).

3. According to the claim 2 with the ultra-thin embedded hard cover with reinforcing strip, its characteristic is that the reinforcing strip (4) and the first plate (1) or the second plate (2) fixed connection by bonding;
The first glue part (D1), the first glue part (D1) and the edge tape bonding part (51) of the edge tape bonding part (51) are fixed on the mating face of the reinforcing strip (4) and the edge strip (5);
There is a second gluing section (D2) on the mating face of the reinforcing strip (4) and the first plate (1), and the second gluing section (D2) is bonded and fixed with the first plate (1).

4. According to claim 1, the ultra-thin embedded hard cover with reinforcing strip, characterized in that:
The reinforcing strip (4) is fixedly connected with the first plate (1) by riveting, screws or bolts.

5. According to the claim 1, a thin embedded hard cover with reinforcing strip, characterized in that:
The ends of the rotating shaft (3) are provided with metal or plastic parts (31), the frontage of the rotating shaft (3) or metal, or plastic parts have a sixth glue part (D6), the sixth glue part (D6) and the edge tape bonding part (51) are bonded.

6. A ultra-thin embedded hard cover with reinforcing strip, the characteristics of which include:
The first plate (1), second plate (2), rotating shaft (3) and edge strip (5);
The n second plates (2) are connected between the two first plates (1) through (n+1) rotating shafts (3), the first plate (1) or the second plate (2) can be folded along the rotating shaft (3).
The edge strip (5) has an edge tape bonding part (51) on one side;
The first plate (1) consists of: The first plate body (11), the short frame (12) and the long frame (13); the short frame (12) and the long frame (13) are two each;
The end of the short frame (12) and the long frame (13) has the third gluing part (D3) and the fourth gluing part (D4); the third gluing part (D3), the fourth gluing part (D4) edge tape bonding part (51) with the edge tape bonding part (51).

7. According to the claim 5, a thin embedded hard cover with reinforcing strip, characterized in that:
The ends of the rotating shaft (3) are provided with metal or plastic parts (31), the frontage of the rotating shaft (3) or metal, or plastic parts have a sixth glue part (D6), the sixth glue part (D6) and the edge tape bonding part (51) are bonded.
